(19) United States
(12) Patent Application Publication
(10) Pub. No.: US 2025/0351119 A1
(43) Pub. Date: Nov. 13, 2025

(54) MAPPING PAGING RESOURCES TO RANDOM ACCESS CHANNEL OCCASIONS

(71) Applicant: LENOVO (SINGAPORE) PTE. LTD., SINGAPORE (SG)

(72) Inventors: Karthikeyan Ganesan, Kronberg Im Taunus (DE); Ravi Kuchibhotla, Chicago, IL (US)

(73) Assignee: LENOVO (SINGAPORE) PTE. LTD., SINGAPORE (SG)

(21) Appl. No.: 18/659,734

(22) Filed: May 9, 2024

(51) Int. Cl. H04W 68/02; H04W 74/0833

(52) U.S. Cl. CPC H04W 68/02; H04W 74/0833

(57) ABSTRACT

Various aspects of the present disclosure relate to mapping paging resources to random access channel (RACH) occasions. An apparatus, such as a UE, receives a paging message during a paging occasion (PO) of a paging frame (PF) of a set of PFs that are consecutive in a time domain. The UE maps, according to a rule, at least one resource associated with the paging message (e.g., one or more POs and/or PFs) to a RACH occasion of a set of RACH occasions. The UE selects the RACH occasion for random access. The UE transmits a RACH message during the selected RACH occasion. In some examples, the UE receives control signaling that indicates the rule.

### TECHNICAL FIELD

The present disclosure relates to wireless communications, and more specifically to resource management for wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like)) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive a paging message during a paging occasion (PO) associated with a paging frame (PF) of a set of paging frames that are consecutive in a time domain, map, according to a rule, at least one resource associated with the paging message to a random access channel (RACH) occasion of a set of RACH occasions, select the RACH occasion for random access, and transmit a RACH message during the selected RACH occasion.

In some implementations of the method and apparatuses described herein, the UE receives control signaling including at least one parameter that indicates the rule, where the control signaling includes radio resource control (RRC) signaling. Additionally, or alternatively, the at least one parameter indicates at least one of a subdivision value, subfactor value, or factor value deriving a resource associated with the PO and the RACH occasion based on a set of resources mapped between a synchronization signal block (SSB) and one or more RACH occasions including the RACH occasion, and the at least one resource includes the resource. Additionally, or alternatively, the control signaling includes at least one additional parameter that indicates that an SSB corresponds to one or more RACH occasions including the RACH occasion, and the rule indicates that the one or more RACH occasions correspond to a set of POs within at least one PF of the set of PFs.

Additionally, or alternatively, the rule indicates a numerical quantity of messages within respective RACH occasions of the one or more RACH occasions that corresponds to the set of POs within the at least one PF of the set of PFs. Additionally, or alternatively, the rule indicates that a group of POs associated with the PF corresponds to at least one RACH occasion including the RACH occasion, and the group of POs includes the PO. Additionally, or alternatively, the rule indicates that at least one of a group of POs associated with the set of PFs or the set of PFs corresponds to one or more RACH occasions including the RACH occasion. Additionally, or alternatively, a quantity of resources associated with the PO in a frequency domain is equal to a quantity of resources associated with the RACH occasion in the frequency domain, and where to select the RACH occasion is based on the quantity of resources associated with the PO in the frequency domain being equal to the quantity of resources associated with the RACH occasion in the frequency domain.

Additionally, or alternatively, each PO associated with the PF or the set of PFs includes a corresponding PO index, each RACH occasion or the set of RACH occasions includes a corresponding RACH occasion index, the rule indicates that each PO associated with the PF or the set of PFs maps to each RACH occasion or the set of RACH occasions in an ascending order of indices, and the at least one resource associated with the paging message is mapped to the RACH occasion according to the ascending order of indices and based on a PO index of the PO associated with the received paging message and a RACH occasion index associated with the RACH occasion. Additionally, or alternatively, the PF includes a set of resources, the PO includes a subset of resources of the set of resources, and at least one of the set of resources or the subset of resources includes the at least one resource. Additionally, or alternatively, the UE receives, from a base station and based on the paging message, a downlink message, where the at least one resource associated with the paging message is mapped to the RACH occasion based on the UE receiving the downlink message.

Some implementations of the method and apparatuses described herein may further include a processor for wireless communication to receive a paging message during a PO associated with a PF of a set of PFs that are consecutive in a time domain, map, according to a rule, at least one resource associated with the paging message to a RACH occasion of a set of RACH occasions, select the RACH occasion for random access, and transmit a RACH message during the selected RACH occasion.

Some implementations of the method and apparatuses described herein may further include a method performed by a UE, the method including receiving a paging message during a PO associated with a PF of a set of PFs that are consecutive in a time domain, mapping, according to a rule, at least one resource associated with the paging message to a RACH occasion of a set of RACH occasions, selecting the RACH occasion for random access, and transmitting a RACH message during the selected RACH occasion.

Some implementations of the method and apparatuses described herein may further include a base station for wireless communication to transmit a paging message during a PO associated with a PF of a set of PFs that are consecutive in a time domain, and receive, during a RACH occasion of a set of RACH occasions, a RACH message based on a mapping, according to a rule, between the RACH occasion and at least one resource associated with the paging message.

In some implementations of the method and apparatuses described herein, the base station transmits control signaling including at least one parameter that indicates the rule, where the control signaling includes RRC signaling. Additionally, or alternatively, the at least one parameter indicates at least one of a subdivision value, subfactor value, or factor value deriving a resource associated with the PO and the RACH occasion based on a set of resources mapped between an SSB and one or more RACH occasions including the RACH occasion, and the at least one resource includes the resource.

Additionally, or alternatively, the control signaling includes at least one additional parameter that indicates that an SSB corresponds to one or more RACH occasions including the RACH occasion, and the rule indicates that the one or more RACH occasions correspond to a set of POs within at least one PF of the set of PFs. Additionally, or alternatively, the rule indicates that a group of POs associated with the PF corresponds to at least one RACH occasion including the RACH occasion, and the group of POs includes the PO. Additionally, or alternatively, the rule indicates that at least one of a group of POs associated with the set of PFs or the set of PFs corresponds to one or more RACH occasions including the RACH occasion. Additionally, or alternatively, a quantity of resources associated with the PO in a frequency domain is equal to a quantity of resources associated with the RACH occasion in the frequency domain.

Additionally, or alternatively, each PO associated with the PF or the set of PFs includes a corresponding PO index, each RACH occasion or the set of RACH occasions includes a corresponding RACH occasion index, the rule indicates that each PO associated with the PF or the set of PFs maps to each RACH occasion or the set of RACH occasions in an ascending order of indices, and the at least one resource associated with the paging message is mapped to the RACH occasion according to the ascending order of indices and based on a PO index of the PO associated with the received paging message and a RACH occasion index associated with the RACH occasion. Additionally, or alternatively, the PF includes a set of resources, the PO includes a subset of resources of the set of resources, and at least one of the set of resources or the subset of resources includes the at least one resource. Additionally, or alternatively, the base station transmits, to a UE and based on the paging message, a downlink message, and where the at least one resource associated with the paging message is mapped to the RACH occasion based on the downlink message.

### BRIEF DESCRIPTION OF THE DRAWINGS

FIG. 1 illustrates an example of a wireless communications system in accordance with aspects of the present disclosure.

FIGS. 2 through 4 illustrates examples of transmission diagrams, in accordance with aspects of the present disclosure.

FIGS. 5 and 6 illustrate examples of resource mapping diagrams, in accordance with aspects of the present disclosure.

FIG. 7 illustrates an example of a signaling diagram, in accordance with aspects of the present disclosure.

FIGS. 8 and 9 illustrate examples of a RACH configuration, in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of a network equipment (NE) in accordance with aspects of the present disclosure.

FIG. 13 illustrates a flowchart of a method performed by a UE in accordance with aspects of the present disclosure.

FIG. 14 illustrates a flowchart of a method performed by a NE in accordance with aspects of the present disclosure.

### DETAILED DESCRIPTION

A wireless communications system can include one or more devices, such as NEs and UEs. The devices can consume energy when transmitting and receiving signaling, as well as to maintain operation of the devices when not transmitting and receiving signaling. To save power, the devices can operate using different modes, such as an active mode when the devices are transmitting and receiving signaling and an inactive mode when the devices are not transmitting and receiving signaling. The signaling can include paging messages, such as from a NE to a UE, that indicates to a device to monitor for a data transmission. Additionally, or alternatively, the signaling can include one or more RACH messages to enable a UE and a NE to establish a connection for transmitting and receiving additional signaling. For example, a NE can transmit a paging message to multiple UEs that can trigger the UEs to enter an active mode to transmit and/or receive signaling. The UEs can enter the active mode and can transmit a first RACH message (e.g., msg1) to establish a connection with the NE. Both the paging messages and the RACH messages can be transmitted to and from the devices in the wireless communications system using resources (e.g., time-frequency resources) allocated for the respective messages. In some cases, resources allocated for paging messages, referred to as paging frames, can be bundled in the time domain to provide for a NE to remain in an inactive state for longer durations. However, the NE transmitting paging messages to UEs using bundled paging occasions can lead to the UEs activating and selecting overlapping resources for transmitting the RACH message, resulting in signaling collisions. The signaling collisions can cause increased signaling overhead due to retransmissions of the RACH message, inefficient use of communication resources, and can even cause a UE to fail to establish a connection with a NE.

As described herein, to reduce signaling collisions, a UE can map one or more resources of a paging message to resources of a RACH message according to a rule. A NE can transmit one or more paging messages to UEs in a paging cycle, which includes one or more resources in a time domain allocated for transmitting the paging messages. The paging cycle can be divided into PFs that include multiple POs. For example, the NE sends the paging messages within POs of a PF. The UE can receive the paging message and can map one or more POs and/or one or more PFs to a RACH occasion using the rule. The RACH occasion can include one or more resources in the time domain allocated for a RACH message. The UE can select a RACH occasion to use for transmitting a RACH message (e.g., msg1) to the NE according to the mapping. In some examples, the rule can indicate that RACH occasions are mapped to POs with a PF, a numerical quantity of messages within RACH occasions that are mapped to the POs, a group of POs that include the paging message are mapped to RACH occasions, and/or a PF that includes the paging message is mapped to the RACH occasions, among other examples. In some cases, the NE can indicate the rule to the UE in control signaling.

Reference is made herein to communicating data or information, such as transmitting and receiving messages (e.g., paging messages and/or RACH messages, among other examples) between a UE and a NE. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

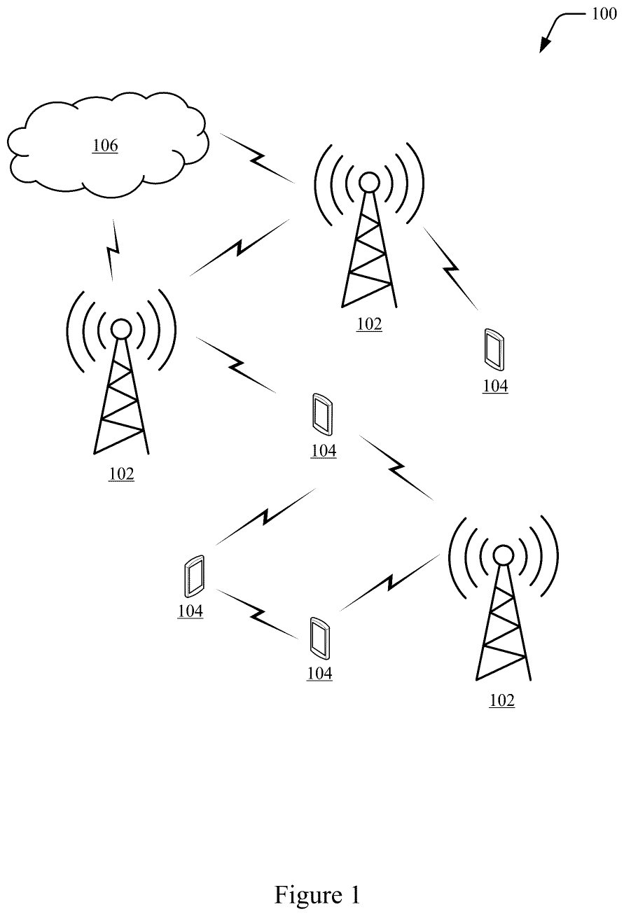

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station) transmits a paging message to a UE 104. The UE 104 receives the paging message and determines a mapping between one or more resources (e.g., POs and/or PFs) of the paging message and a RACH occasion for transmitting a RACH message. In some examples, the UE 104 determines the mapping using a configured rule that indicates for the UE 104 to map one or more POs to the RACH occasion and/or one or more PFs to the RACH occasion, among other examples. The UE 104 selects a RACH occasion for performing random access. For example, the UE 104 can transmit a RACH message during the RACH occasion.

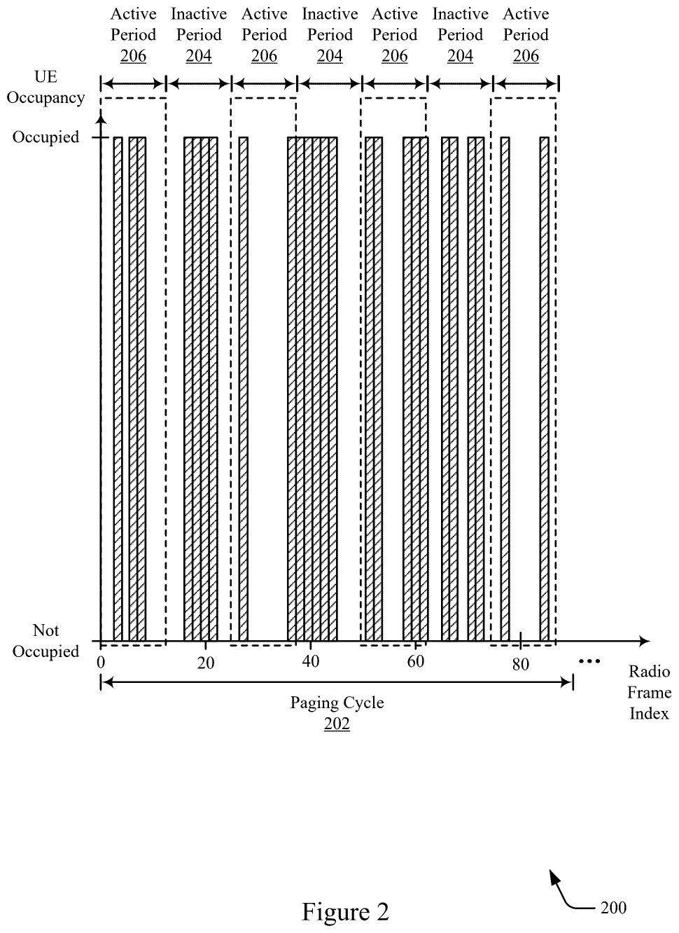

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 can be implemented by a UE and a NE, which may be examples of a UE 104 and a NE 102 as described with reference to FIG. 1. The NE and/or the UE can operate in one or more modes, including an active mode and an inactive mode, to reduce power consumptions of the NE and/or the UE.

In some examples, a NE and a UE can transmit and receive signaling, such as control signaling and/or data. The NE and the UE can transmit and receive the signaling via one or more communication links. For example, the NE can transmit signaling to the UE via a downlink communication link, while the UE can transmit signaling to the NE via an uplink communication link. The signaling can occupy one or more time-frequency resources, which can also be referred to as communication resources or resources. For example, the NE and/or the UE can transmit signaling using one or more radio frames. A radio frame is a unit of time used in wireless communication systems that represents a fixed duration of time during which data is transmitted over the air interface between the NE and the UE. A radio frame can be further divided into smaller units of time, such as slots or occasions. The NE and/or the UE can transmit the signaling using one or more frequency resources, including, but not limited to, frequency bands, component carriers (CCs), bandwidth parts (BWPs), among other example frequency resources.

A radio frame can be occupied and/or not occupied by a transmission, such as from a UE. That is, for UE occupancy of radio frames, a radio frame that includes a transmission from a UE can be occupied and a radio frame that does not include a transmission from a UE can be not occupied. A radio frame can have an index in the time domain. A paging cycle 202 can span one or more radio frame indexes. The paging cycle 202 can refer to a period of time allocated for transmission of paging messages. A NE can transmit the paging messages during one or more radio frames within the paging cycle 202.

In some examples, a NE and/or a UE can operate according to one or more modes or operation states. For example, the NE and/or the UE can implement discontinuous transmission (DTX) and discontinuous reception (DRX) techniques to reduce a power consumption at the NE and/or the UE. DTX is a technique used to conserve power by temporarily suspending the transmission of data from a UE to a NE during a time period of time, referred to as an inactive period 204. During the inactive period 204, the UE and/or the NE can enter a sleep mode, an idle mode, or an inactive mode, in which the UE and/or the NE reduces (e.g., or suspends entirely) transmission of signaling. During one or more active periods 206, the UE and/or the NE can enter an active mode to transmit signaling. By avoiding transmission during idle periods, DTX reduces power consumption at the UE and/or the NE, extending battery life and conserving energy. Additionally, or alternatively, DRX is a technique used to conserve power by allowing a receiver of the UE and/or the NE to enter a sleep mode or other low-power state during time periods when the UE and/or the NE is not expecting incoming data (e.g., inactive periods 204). By avoiding reception during inactive periods 204, DRX reduces power consumption at the UE and/or the NE, extending battery life and conserving energy.

In some examples, reducing power consumption at the UE and/or the NE can reduce emissions by the UE and/or the NE, as well as reduce an operating expense related to implementing UEs and NEs with a continued rise in mobile data traffic (e.g., 6.4 gigabytes (GB) per user per month). In some cases, 5G NR improved energy-efficiency per GB over previous generations of mobility. However, new 5G use cases and the adoption of millimeter Wave (mm-Wave) communications may cause an increase in NEs to serve UEs over a geographic coverage area, leading to higher emissions.

Network energy saving can lead to environmental sustainability by reducing environmental impact (e.g., greenhouse gas emissions) and can reduce operational cost. As 5G is becoming pervasive across industries and geographical areas, handling more advanced services and applications that use relatively high data rates (e.g., greater than a threshold data rate, including extended reality (XR)), networks are becoming denser, use more antennas, have an increase in bandwidths, and more frequency bands. In some examples, the energy cost on a mobile network accounts for a relatively large amount of (e.g., 23%) of a total operator cost. The NEs and other devices in a RAN account for a relatively large amount (e.g., most) of the energy consumption, such as from an active antenna unit (AAU), with data centers and fiber transport accounting for a relatively smaller share. The power consumption of a RAN can be split into two parts, including a dynamic part which is consumed when data transmission and/or reception is ongoing, and a static part which is constantly consumed time to maintain the operation of the devices in the RAN (e.g., even when the data transmission and/or reception is not on-going).

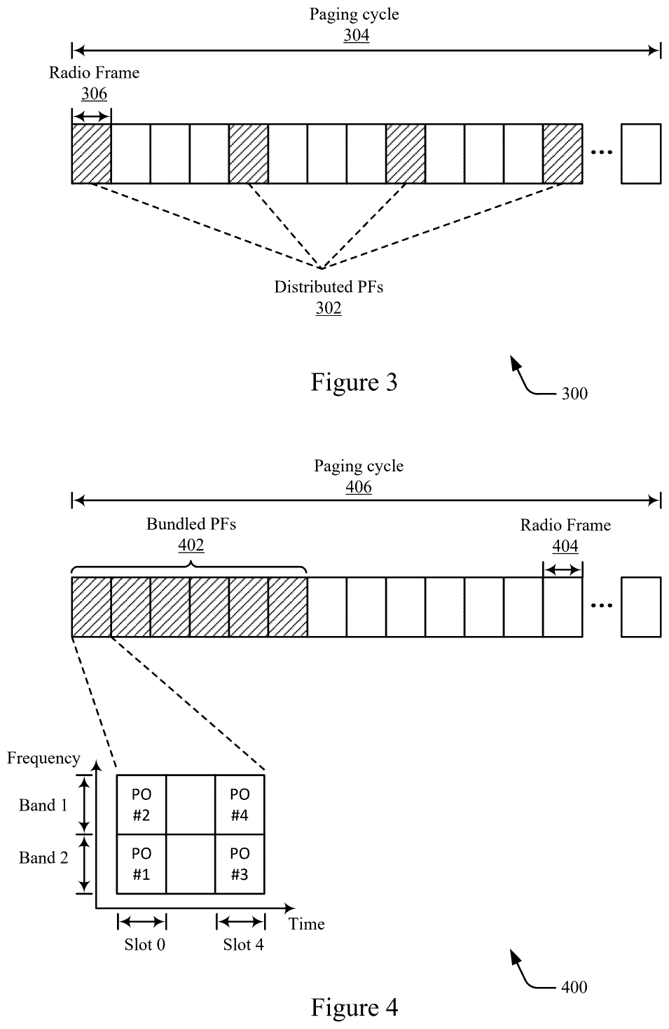

The NEs can implement (e.g., activate) one or more network energy saving configurations in a cell, such as an idle mode cell DTX and/or DRX configuration. The NEs can transmit one or more channels, such as a paging channel and a physical RACH within the active periods 206 of the cell to save power. However, conventional techniques for transmitting paging channels (e.g., during POs within PFs of the paging cycle 202) are designed for a cell that is always in an active mode (e.g., an always ON cell). A paging channel with resource allocated according to conventional techniques may be outside of an active period 206. Thus, a UE may not be page, or the NE may wake up (e.g., enter an active mode) periodically to transmit a paging message to the UE, which is described in further detail with respect to FIGS. 3 and 4. In some examples, the paging message may wake up the UE (e.g., cause the UE to enter an active mode). The UE can transmit one or more RACH messages to the NE using a mapping between the resources used for the paging message and the resources used for the RACH message.

FIG. 3 illustrates an example of a transmission diagram 300 in accordance with aspects of the present disclosure. In some examples, the transmission diagram 300 implements or is implemented by aspects of the wireless communications system 100 and/or the transmission diagram 200. For example, the transmission diagram 300 can be implemented by a UE and a NE, which may be examples of a UE 104 and a NE 102 as described with reference to FIG. 1.

In some examples, a NE may continuously operate in an active mode, such as in an always ON configuration. Additionally, or alternatively, the NE can operate in one or more modes, including an active mode with an active period and an inactive mode (e.g., idle mode) with an inactive period. While in an active mode, the NE can transmit one or more paging messages in distributed PFs 302. For example, the NE can be configured with or can determine a paging cycle 304 for transmitting one or more paging messages. The paging messages can include, but are not limited to, mobile terminated call paging messages, mobile originated call paging messages, short message service (SMS) paging messages, system information paging, and/or emergency paging messages, among other examples. The paging cycle 304 can span any numerical quantity of radio frames 306. The paging cycle 304 can include any numerical quantity of distributed PFs 302. In some examples, the distributed PFs 302 can be periodic, such that there is a distributed PF 302 that repeats after a numerical quantity of radio frames 306 (e.g., every fourth radio frame 306). The NE can enter an inactive mode between respective distributed PFs 302 and can wake up (e.g., enter an active mode) to transmit the paging messages during the distributed PFs 302. However, if the periodicity of the distributed PFs 302 is relatively short, then the inactive period of the NE between distributed PFs 302 can also be relatively short (e.g., less than a threshold numerical quantity of radio frames 306). A relatively short inactive period can lead to increased power consumption at the NE when compared with a relatively long inactive period (e.g., greater than a threshold numerical quantity of radio frames 306). Thus, to reduce power consumption by increasing an inactive period of the NE between PFs, the NE can bundle PFs in the time domain, which is described in further detail with respect to FIG. 4.

FIG. 4 illustrates an example of a transmission diagram 400 in accordance with aspects of the present disclosure. In some examples, the transmission diagram 400 implements or is implemented by aspects of the wireless communications system 100, the transmission diagram 200, and/or the transmission diagram 300. For example, the transmission diagram 400 can be implemented by a UE and a NE, which may be examples of a UE 104 and a NE 102 as described with reference to FIG. 1.

In some examples, such as to reduce power consumption by increasing an inactive period, a NE can bundle one or more PFs (e.g., bundled PFs 402) in the time domain. For example, the PFs can occupy consecutive time resources (e.g., radio frames 404). While in an active mode, the NE can transmit one or more paging messages in the bundled PFs 402. For example, the NE can be configured with or can determine a paging cycle 406 for transmitting one or more paging messages. The paging messages can include, but are not limited to, mobile terminated call paging messages, mobile originated call paging messages, short message service (SMS) paging messages, system information paging, and/or emergency paging messages, among other examples. The paging cycle 406 can span any numerical quantity of radio frames 404. The paging cycle 406 can include any numerical quantity of bundled PFs 402. The NE can enter an active mode to transmit the bundled PFs 402 and can enter an inactive mode after transmitting the bundled PFs 402. Thus, the NE may enter an active mode once in a paging cycle 406.

In some examples, a NE can use one or more PFs and POs to transmit paging messages to reduce use of network resources (e.g., time-frequency resources). A PF is a radio frame 404 in which one or more POs are being transmitted (e.g., the PO #1 through the PO #4). The PF can be defined in control signaling, such as a System Information Block Type 2 (SIB2) and can be set to a value that aligns with the radio frame boundary of a cell serving a UE. A PO is a subframe within a PF with a paging-radio network temporary identifier (P-RNTI) transmitted on a physical downlink control channel (PDCCH) addressing the paging message. The UE can wake up (e.g., enter an active mode) in a defined subframe (e.g., a subframe 0, 4, 5 or 9) within a radio frame. The subframes within a PF in which the UE wakes up are referred to as POs. The PO is determined by the combination of the paging cycle 406 and a radio frame number (RFN) of the cell. The PO is used to minimize the signaling overhead by reducing a numerical quantity of subframes that the network searches for idle UEs. The paging cycle 406 determines the interval between consecutive POs, The RFN of the cell is a counter that increments with every radio frame 404 and is used to determine the subframes that correspond to the PO. The PF can be calculated according to Equation 1:

$$PF = SFN mod ( T ) = ( \frac{T}{N} ) \times ( {UE}_{ID} mod ( N ) ) , \qquad ( 1 )$$

where T is the paging cycle 406 and T=I_{DRX} cycle length in radio frames 404. In some cases, N=Min (T, nB), where nB is a total number of POs in one I_{DRX} cycle broadcast within SIB2 and can have values of {4T, 2T, T, T/2, T/4, T/8, T/16, T/32}, N can have values of {T, T/2, T/4, T/8, T/16, T/32}, and UE_{ID}=TMSI mode (1024). In some examples, a formula to compute POs is extracted from a look-up table (e.g., Table 1 for frequency division duplex (FDD) and Table 2 for time division duplex (TDD)) which is indexed using

$${N}_{s} = Max ( 1 , \frac{nB}{T} ) and {i}_{s} = Floor ( \frac{{UE}_{ID}}{N} ) Mod ( {N}_{s} ) ,$$

where Nₛ is the number of POs in a PF and is indicates the subframe number (e.g., PO) in the PF, the value of which is defined for each value of Nₛ.

TABLE 1

| Nₛ | PO when iₛ = 0 | PO when iₛ = 1 | PO when iₛ = 2 | PO when iₛ = 3 |
|---|---|---|---|---|
| 1 | 9 | N/A | N/A | N/A |
| 2 | 4 | 9 | N/A | N/A |
| 4 | 0 | 4 | 5 | 9 |

TABLE 2

| Nₛ | PO when iₛ = 0 | PO when iₛ = 1 | PO when iₛ = 2 | PO when iₛ = 3 |
|---|---|---|---|---|
| 1 | 0 | N/A | N/A | N/A |
| 2 | 0 | 5 | N/A | N/A |
| 4 | 0 | 1 | 5 | 6 |

In some examples, such as when Nₛ=1, there is one PO (e.g., one subframe where a paging message is carried) within a PF and the subframe number is 9. When Nₛ=2, there are two POs (e.g., two subframes where a paging message is carried) within a PF and the subframe number is 4 and 9. When Nₛ=4, there are four POs (e.g., four subframes where paging message is carried) within a PF and the subframe number is 0, 4, 5 and 9.

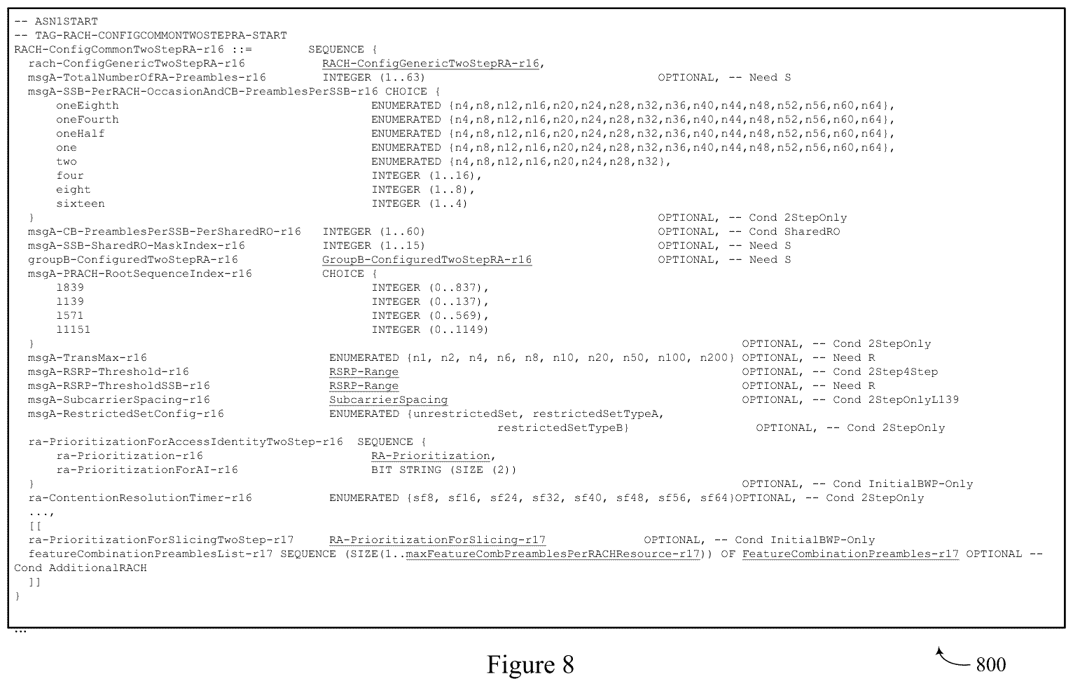

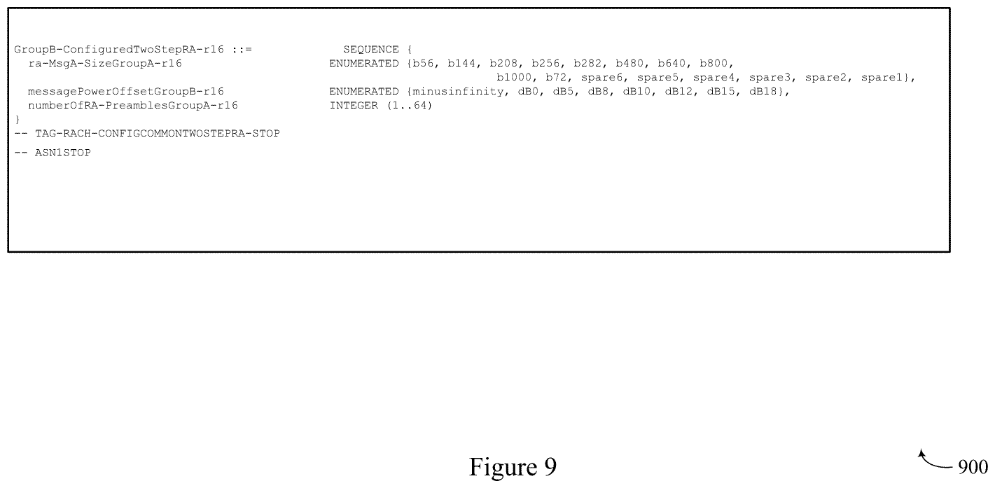

In some examples, a NE and/or UE can be configured with a numerical quantity of SSBs per RACH occasion (e.g., with a ssb-perRACH-OccasionAndCB-PreamblesPerSSB configuration). For example, a CHOICE portion of the configuration can include information about the number of SSBs per RACH occasion. A value of the field being oneEigth corresponds to one SSB associated with 8 RACH occasions, a value of the field being oneFourth corresponds to one SSB associated with 4 RACH occasions, and so on. An ENUMERATED portion of the configuration indicates a number of contention-based preambles per SSB. A value n4 corresponds to 4 contention-based preambles per SSB, a value n8 corresponds to 8 contention-based preambles per SSB, and so on. The total number of contention-based preambles in a RACH occasion is given by CB-preambles-per-SSB*max(1, SSB-per-rach-occasion). A value of 4 corresponds to 4 SSB associated with a RACH occasion. The configuration is illustrated in FIGS. 8 and 9.

In some examples, a number of RACH transmission occasions FDMed in one time instance has a maximum value (e.g., 8), meaning the NE can have up to the maximum value of frequency resource instances over one instance of time. The mapping between an SSB and RACH occasion is defined by one or more RRC parameters (e.g., a msg1-FDM parameter and an ssb-perRACH-OccasionAndCB-PreamblesPerSSB parameter). The msg1-FDM parameter specifies how many RACH occasions are allocated in a frequency domain (e.g., at the same location in time domain). The ssb-perRACH-OccasionAndCB-PreamblesPerSSB parameter specifies how many SSBs can be mapped to one RACH occasion and how many preamble indexes can be mapped to a single SSB.

If the PFs are bundled in the time domain, then a numerical quantity of SSBs for the bundled PFs 402 is reduced. If a cell load and/or paging load is the same, then RACH collisions increase due to fewer SSBs, which results in fewer SSB to RACH occasion mappings. Due to the fewer SSB to RACH occasion resource mapping and with the paging load unchanged, the UEs that are paged using the bundled PFs 402 may select a same resource occasion for transmission of a RACH message, resulting in collision. To solve RACH collisions, the NE and the UE can implement resource management by factoring PFs and/or POs into the SSB to RACH resource mapping.

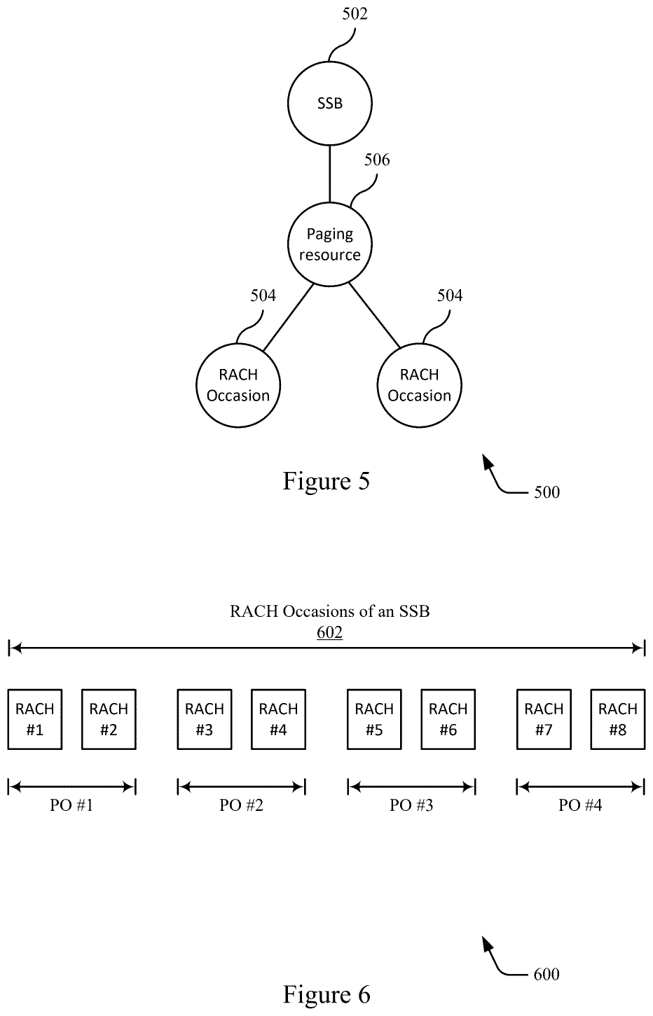

In some examples, the SSB to RACH resource mapping is defined by the higher layer parameter ssb-perRACH-OccasionAndCB-PreamblesPerSSB, which can be enhanced to include the mapping of PFs or POs (e.g., resources that include a paging message) to the RACH resource partitioning, thereby reducing the RACH collisions due to bundled PFs 402. The enhancements to the SSB to RACH resource mapping to include mapping of PFs or POs is described in further detail with respect to FIGS. 5 and 6. In some examples, POs can be time division multiplexed (TDMed) in one or more time resources, referred to as slots. TDM techniques include a device transmitting multiple signals over a single communication channel by dividing the channel into discrete time slots. A signal is allocated a time slot within the channel, and the signals are transmitted sequentially. Signals from different sources can be interleaved (e.g., multiplexed) and transmitted sequentially within the time slots. For example, one or more POs (e.g., the PO #1 and the PO #2) can be transmitted in a slot with an index of 0, while one or more other POs (e.g., the PO #3 and the PO #4) can be transmitted in a slot with an index of 4. In some examples, the POs are TDMed in slots with indexes 0, 4, 5, and 9, which is indicated to the UE by means of number of POs in a paging cycle 406 and the number of PFs within the paging cycle 406 (e.g., the bundled PFs 402) is also indicated to the UE using N. The UE calculates an PF index according to Equation 1.

For a compact paging structure with a PF burst transmission to minimize the frequent network wake up (e.g., bundled PFs 402), one or more POs can be configured by using TDMed and/or frequency division multiplexed (FDMed) paging occasions within a PF. The POs can be configured in consecutive slots, and in those slots the paging occasions can also be configured in the frequency domain resources, such that the NE can enter an inactive mode earlier by having more POs within a shorter time period. FDM techniques include a device transmitting multiple signals concurrently over a single communication channel by allocating a signal a unique frequency band within the channel. For example, PO #2 and PO #4 can be sent using a frequency band 1, while the PO #1 and the PO #3 can be sent using a frequency band 2.

FIG. 5 illustrates an example of a resource mapping diagram 500 in accordance with aspects of the present disclosure. In some examples, the resource mapping diagram 500 implements or is implemented by aspects of the wireless communications system 100, the transmission diagram 200, the transmission diagram 300, and the transmission diagram 400. For example, the resource mapping diagram 500 can be implemented by a UE and a NE, which may be examples of a UE 104 and a NE 102 as described with reference to FIG. 1. The NE and/or the UE can implement mapping between resources used for a paging message and resources used for a RACH message to reduce, or prevent, collisions between RACH messages.

In some examples, a NE can transmit an SSB 502 to one or more UEs. For example, the NE can periodically transmit (e.g., broadcast) SSBs 502 to UEs to provide synchronization and timing information to the UEs within a coverage area of the NE. The UEs can use the information included in the SSBs 502 to synchronize signaling timing with a timing of the NE and to obtain system information. For example, the SSBs 502 can include primary synchronization signals (PSSs) and secondary synchronization signals (SSSs), which are used by UEs to detect and synchronize with a frame timing and frequency of the NE. The PSSs and SSSs provide timing and cell identity information, providing for the UEs to identify and select a cell with a greatest signal strength and/or quality for connection. The SSBs 502 can additionally, or alternatively, carry system information, such as cell identity, bandwidth, reference signal measurements, and other parameters used by UEs to access and operate within the network.

As described with reference to FIGS. 3 and 4, there is a mapping configuration between the SSB 502 and a RACH occasion 504 that a UE selects to transmit a RACH message (e.g., msg1). In some examples, the mapping configuration can be enhanced to include a mapping between SSBs 502, paging resources 506, and RACH occasions 504 to reduce collision of RACH messages from different UEs. For example, a mapping definition rule may be defined and/or configured to map resources between the POs within a PF or a group of POs from one or more PFs to that of RACH occasions. There can be more POs or PFs mapped to a single RACH occasions, a single PO mapped to a set of RACH occasions 504, or any combination thereof. Thus, the paging resource can include one or more POs and/or one or more PFs.

The mapping rule can be implemented by defining a sub-divisor, subfactor, factor, or any combination thereof to determine the configuration of RACH resources mapped between the paging resources 506 (e.g., POs and/or PFs) and RACH occasions 504 from that resource configured and mapped between an SSB 502 and RACH occasions 504. In some other examples, a new configuration provides a separate RACH resource mapped between the paging resource 506 and the RACH occasions 504 irrespective of a configured RACH resource provided between the SSB 502 and RACH occasions 504.

A new association period may be defined between the SSB 502, the paging resource 506, and RACH occasions 504, such that within a defined time the SSB beams, paging beams, POs, PFs, or any combination thereof configured in a cell can be mapped to RACH occasions 504. In some examples, resources within an active DTX and/or DRX time period for a cell can be considered for the defined time period. Thus, the SSB beams, paging beams, POs, PFs, or any combination thereof configured within an active DTX and/or DRX time periods of a cell can be mapped to RACH occasions 504. The defined time period does not consider resources configured outside the active time period of the DTX and/or DRX configuration. The defined time period factors in the mapping of the paging resource 506 to RACH occasions 504 in addition to the mapping of SSB beams to the RACH occasions 504. Otherwise, a separate association can be defined to map the paging resources 506 to SSB beams in addition to a defined time period between the SSB 502 and the RACH occasions 504. Otherwise the time period is set to a smallest and/or greatest value that satisfies an association between the paging resources 506 to the RACH occasions 504 or the SSB beams to the RACH occasions 504.

The SSBs 502 are transmitted within an SSB burst, and the SSB burst periodicity can be preconfigured or defined. The SSB transmission occurs prior to transmission of the POs, a paging early indication (PEI), and/or a low-power wakeup signal (LPWUS) to provide downlink synchronization prior to reading downlink messages, such as the PEI, LPWUS, or paging messages. Due to the PF transmission in a burst manner, the number of SSBs 502 transmitted prior to the paging burst may be reduced. The reduced number of SSBs 502 may result in increased RACH message collision due to a fewer RACH resources resulting from fewer SSB 502 to RACH occasions 504 mapping and reduced synchronization (e.g., the compact frame structure is a burst-like frame structure with reduced or no gaps between consecutive occasions or frames).

The RACH message collisions due to a paged UE selecting a same RACH resource can be reduced by introducing a new mapping definition of paging resources 506 to an SSB 502 to RACH occasion 504 resource partitioning. Assuming that the paging monitoring occasions are quasi-collocated (QCLed) with that of the SSB beams, the RACH resources can be further partitioned (e.g., divided, sub-divided, factored, or sub-factored) by taking into consideration the POs in a PF or PFs. For example, the SSB 502 and RACH occasion 504 mapping definition can be enhanced to include a mapping of the paging resource 506 to a RACH occasion 504. The SSB 502 and the RACH occasion 504 mapping can include a definition that one SSB 502 is associated with X RACH occasions 504, when X is greater than one. The SSB 502 and the RACH occasion 504 mapping can include a definition that there are N SSBs 502 associated with X RACH occasions 504, when X is greater than or equal to one. The SSB 502 and the RACH occasion 504 mapping can include a definition that a field for the RACH message (e.g., msg-1FDM) can be equal to one or greater than one.

In some examples, if msg1-FDM (e.g., a RACH FDMed resource) and PO-FDM (e.g., POs FDMed resources) are configured with a same number of FDMed resources, then there is a one to one frequency mapping of resource between the paging resources 506 and the RACH occasions 504 in the frequency domain. Thus, the paged UEs selects a same RACH occasion 504 in the frequency domain in the paging frequency resource the UE received a paging message. In some other examples, there may be a selection definition between the paging resource 506 and the RACH occasion 504, such that the (e.g., ascending and/or increased) order of a paging resource 506 mapped to the (e.g., ascending and/or increased) order of RACH occasion 504. For example, the paging resources 506 can be assigned indexes, such as a radio frame indexes and/or slot indexes for the time domain, or frequency band indexes in the frequency domain. The RACH occasion 504 and/or the SSB 502 can also be assigned indexes, such as the radio frame indexes and/or the slot indexes. The UE can determine the paging resource 506 by mapping the index of the paging resource 506 to one or more indexes of an SSB 502 and/or RACH occasions 504. For example, the RACH occasions 504 are mapped consecutively per corresponding index of a synchronization signal (SS), a physical broadcast channel (PBCH) block (e.g., the SSB 502), paging resources 506, or any combination thereof. The indexing of the RACH occasion 504 indicated by the mask index value is reset per mapping cycle of consecutive RACH occasions 504 per a PO and/or PF index. The UE selects a RACH occasion 504 for a RACH transmission indicated by a RACH mask index value for the indicated POs and/or PFs index in the first available mapping cycle.

In some examples, the ordering of the RACH occasions 504 can be in increasing order of frequency resource indexes for frequency multiplexed RACH occasions 504, in increasing order of time resource indexes for time multiplexed RACH occasions 504 within a RACH slot, and/or in increasing order of indexes for RACH slots. In some other examples, when a new sub-divisor, subfactor, factor, or any combination thereof to determine the configuration of RACH resources mapped between the paging resources 506 and the RACH occasions 504 from that of a resource configured and mapped between an SSB 502 and RACH occasions 504, the ordering of the RACH occasions 504 determined according to a priority. For example, the RACH occasions 504 are selected in increasing order of SSB index. Within each SSB index, the RACH occasions 504 are selected in the increasing order of PO index or PF index. Thus, the selection of RACH occasions 504 can be in increasing order of frequency, followed by increasing order of time resource index within a RACH slot, followed by increasing order of RACH.

For example, N POs within a PF or PFs can be mapped to a single RACH occasion 504. A new RRC parameter may be introduced in addition to an SSB 502 to RACH occasion 504 mapping parameter to map the PO (e.g., or other paging resource 506) to the RACH occasion mapping. The new RRC parameter, PO-perRACH-OccasionAndCB-PreamblesPerPO, can specify the paging resource 506 (e.g., POs within a PF or PFs) mapped to one or more RACH occasions 504. Another parameter may be introduced to indicate a number of POs within a PF that can be grouped together to map to an SSB 502 to RACH occasion 504 mapping. The grouped POs can be assigned an SSB 502 to RACH occasion 504 mapping according to a parameter, PO-perRACH-OccasionAndCB-PreamblesPerPO. Another parameter may be introduced to map the POs of a number of consecutive PFs or consecutive PFs grouped together to map to one or more RACH occasions 504 of an SSB beam configured according to ssb-perRACH-OccasionAndCB-PreamblesPerSSB.

In some examples, the NE can transmit explicit signaling to a UE to map the paging resource 506 to the RACH occasions 504. The paged UEs can select a RACH resource (e.g., one or more RACH occasions 504) for transmission of a RACH message according to the explicit signaling. The SSB 502 to RACH resource mapping can include a new field to indicate the partitioning of the RACH occasions 504 to the paging resources 506. For example, if one SSB 502 is mapped (e.g., associated) to X RACH occasions 504, where X is greater than one, then the RACH occasions 504 are further partitioned according to the POs within a PF using the parameter PO-perRACH-OccasionAndCB-PreamblesPerPO.

In some examples, there can be mapping between a PF and a RACH occasion 504 (e.g., without involving the SSB 502 to RACH occasion 504 mapping and/or in addition to the SSB 502 to RACH occasion 504 mapping) to select a RACH resource for transmission to minimize collision. For example, an additional RACH resource may be configured to reduce, or prevent, RACH collisions due to compact POs or PFs. The NE can transmit a configuration that indicates for UEs with mobile terminated traffic to select a paging resource 506 to RACH occasion 504 mapping, while the UEs with mobile originated traffic may select the SSB 502 to RACH occasion 504 mapping. In some cases, when multiple SSB beams are configured to be mapped to a single RACH occasion 504, then a configuration with a new RACH occasion 504 is activated to map the paging resources 506 to the RACH occasion 504 to reduce RACH collisions. In some examples, the mapping between the paging resource 506 to the SSB 502 to RACH occasion 504 mapping may be applicable for UEs with mobile terminated traffic, while UEs with mobile originated traffic can use an SSB 502 to RACH occasion 504 mapping definition according to FIGS. 8 and 9. In some cases, the RACH occasions 504 due to the mapping between SSB 502 to RACH occasion 504 mapping and the SSB 502, paging resource 506, and RACH occasion 504 mapping and/or paging resource 506 to RACH occasion 504 mapping can share a same set of RACH occasions 504. The UE selection of RACH occasions 504 may follow the respective mapping rules.

In some examples, the mapping between the paging resource 506 and RACH occasion 504 can account for the RACH resource spanning multiple time periods to reduce or prevent congestion of RACH transmissions within the RACH resources (e.g., RACH occasions 504) and paging messages within the paging resources 506. In some examples, a new association time period can be defined between one or more paging resources 506 and corresponding transmit beams of respective paging messages, which can be mapped to RACH occasions 504. The new association time period can be defined when the network configures additional RACH occasions 504 for paging. In some examples, an existing association time period between an SSB 502 and RACH occasions 504 can be redefined to include POs or PFs mapping, hence the association period can be defined as at least once the SSB beams are mapped to RACH occasions 504 and at least once POs or PFs are mapped to RACH occasions 504. In some examples, the association time period can be defined with separate values according to different device types. The device types can include, but are not limited to, enhanced mobile broadband (eMBB), IoT, ultra-reliable low-latency communications (URLLC), among others, due to the eMBB using a faster access to the network and IoT tolerating latency to access the network. The longer association time period for one or more devices may provide for relaxed selection of RACH resources to access the network (e.g., for the IoT devices), thereby reducing the congestion.

In some examples, the association time period can be redefined when cell DTX and/or DRX are configured for a cell (e.g., a network energy savings (NES) cell with bundled PFs), where the association time period can be within a single period of a cell active time. In some other examples, the SSBs 502 can be within the cell DTX active time and RACH can be within the cell DRX active time period. However, the association time period can include at least a duration over which the SSB beams within a cell DTX active time period can be mapped to a RACH occasion 504 within a next cell DRX active time period, where that the association time period covers the cell DTX and cell DRX active periods. In some examples, the association time period can have relaxed time association, where at least once the SSB beams within a cell DTX active time period can be mapped to a RACH occasion 504 across one or more cell DRX active time periods. Similarly, the association time period can be mapped between the POs or PFs (e.g., the paging resource 506), RACH occasions 504, and SSB 502. Additionally, or alternatively, the association time period can be mapped between the POs or other paging resource 506 and RACH occasions 504.

FIG. 6 illustrates an example of a resource mapping diagram 600 in accordance with aspects of the present disclosure. In some examples, the resource mapping diagram 600 implements or is implemented by aspects of the wireless communications system 100, the transmission diagram 200, the transmission diagram 300, the transmission diagram 400, and the resource mapping diagram 500. For example, the resource mapping diagram 600 can be implemented by a UE and a NE, which may be examples of a UE 104 and a NE 102 as described with reference to FIG. 1. The NE and/or the UE can implement mapping between resources used for a paging message and resources used for a RACH message to reduce, or prevent, collisions between RACH messages.

In some examples, an SSB can be mapped to one or more RACH occasions, such that there are one or more RACH occasions of an SSB 602. For example, one SSB can be associated with (e.g., mapped to) multiple RACH occasions according to a parameter value in control signaling. If the parameter, perRACH-OccasionAndCB-PreamblesPerSSB, has a value of 1/8, then the SSB can be mapped to 8 RACH occasions (e.g., RACH #1 through RACH #8). A value of the parameter, PO-perRACH-OccasionAndCB-PreamblesPerPO, can indicate how many paging occasions there are per RACH occasion. For example, if the value is set to ½, then there is one PO within a PF associated to (e.g., mapped to) 2 RACH occasions out of the 8 RACH occasions. For example, if there are 4 paging occasions configured to map to the RACH occasions of an SSB 602, then 4 such paging occasions are mapped to 8 RACH occasions, where one paging occasion is mapped to two RACH occasions. For example, PO #1 is mapped to RACH #1 and RACH #2, PO #2 is mapped to RACH #3 and RACH #4, PO #3 is mapped to RACH #5 and RACH #6, and PO #4 is mapped to RACH #7 and RACH #8.

In some examples, such as when msg1-FDM (e.g., RACH FDMed resource) and PO-FDM (e.g., paging occasions FDMed resources), the UE may be configured with different FDMed resources. Thus, the mapping between the frequency domain resource between POs and RACH occasions can be specified using the value of the parameter that indicates the sub-divisor, subfactor, factor, or any combination thereof (e.g., a value of the parameter PO-perRACH-OccasionAndCB-PreamblesPerPO). In some other examples, the number of preambles within each RACH occasion belonging to an SSB (e.g., the RACH occasions of the SSB 602) can be partitioned for paging resources using a new RRC parameter that includes a sub-divisor, subfactor, factor, or any combination thereof values. The RRC parameter can be configured separately, such that out of N preambles configured in each RACH occasions belonging to an SSB, a new RRC parameter of (1/M) factor means preambles (N/M) can be configured for a paging resource. In some examples, there can be any numerical quantity of POs mapped to any numerical quantity of RACH occasions. When msg1-FDM=8, and perRACH-OccasionAndCB-PreamblesPerSSB=1/8, then PO-perRACH-OccasionAndCB-PreamblesPerPO=1/2 and 4 POs are mapped to RACH occasions for an SSB 602, then 8 FDMed RACH occasions are partitioned by 4 POs, where each PO mapping to 2 RACH occasions.

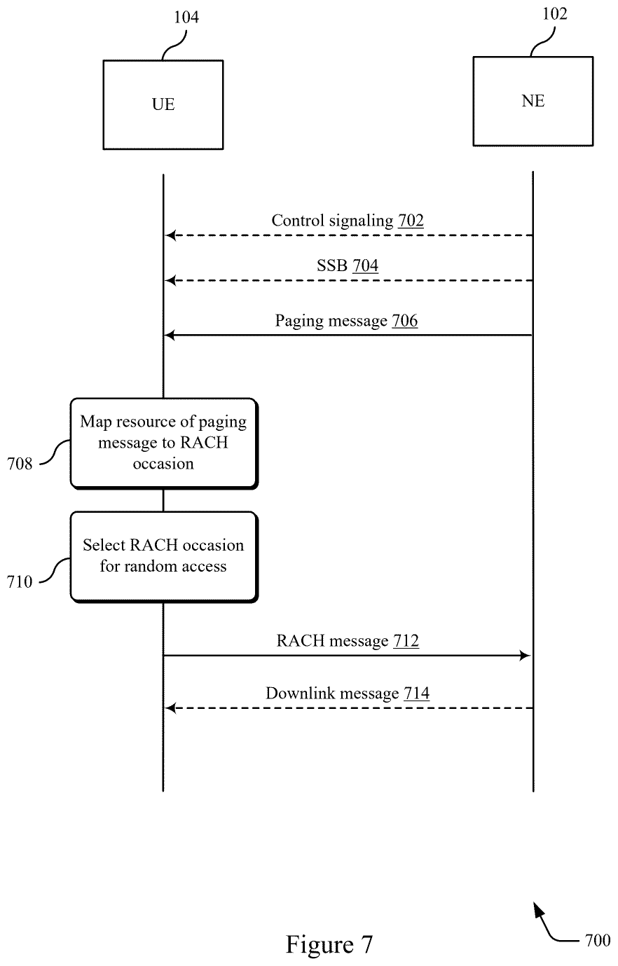

FIG. 7 illustrates an example of a signaling diagram 700 in accordance with aspects of the present disclosure. In some examples, the signaling diagram 700 may implement aspects of the wireless communications system 100, the wireless communications system 100, the transmission diagram 200, the transmission diagram 300, the transmission diagram 400, the resource mapping diagram 500, and the resource mapping diagram 600. The signaling diagram 700 may illustrate an example of selecting a RACH occasion for a RACH message transmission using a mapping between RACH occasions and paging resources at a UE 104. The UE 104 and the NE 102 can be examples of a UE 104 and a NE 102 as described with reference to FIG. 1. Alternative examples of the following may be implemented, where some processes are performed in a different order than described or are not performed. In some cases, processes may include additional features not mentioned below, or further processes may be added.

In some examples, at 702, the NE 102 can transmit control signaling to the UE 104. The control signaling can include one or more parameters that explicitly indicate a mapping rule for a UE 104 to use to map paging resources to RACH occasions. The control signaling can include RRC signaling. The parameters can indicate at least one of a subdivision value, subfactor value, or factor value that the UE 104 can use to derive a paging resource and the RACH occasion from a resources mapped between an SSB and RACH occasions. In some cases, the control signaling includes at least one additional parameter that indicates that an SSB is mapped to RACH occasions.

In some cases, at 704, the NE 102 can transmit an SSB to the UE 104. The UE 104 can use a configuration for mapping the SSB to RACH occasions to determine a mapping between the paging resources and the RACH occasions.

At 706, the NE 102 can transmit a paging message to the UE 104. For example, the UE 104 can receive a paging message during a PO of a PF from a set of PFs that are consecutive in a time domain. The PFs can be bundled (e.g., consecutively) in the time domain to increase a duration over which the NE 102 can enter an inactive mode to reduce power consumption at the NE 102. Each PF can include any numerical quantity of POs. The PFs can span a paging cycle for the NE 102, which can be configured or defined by the NE 102 based on a DTX and/or DRX cycle of the NE 102. For example, the paging cycle can span at least a portion of an active period of the DTX and/or DRX cycle.

At 708, The UE 104 can map at least one resource of the paging message to a RACH occasion of a set of RACH occasions. The UE 104 can map the resource of the paging message, referred to as a paging resource, according to a rule specified by the NE 102. In some examples, the rule can indicate that the RACH occasions are mapped to POs within a PF. Additionally, or alternatively, the rule can indicate a numerical quantity of messages within respective RACH occasions that map to the POs within the PF. In some cases, the rule indicates that a group of POs of the PF are mapped to one or more RACH occasions, where the POs include the PO that carries the paging message. In some other cases, the rule indicates that at least one of a group of POs or the PFs are mapped to one or more RACH occasions.

In some variations, each PO of the PF or the PFs has a corresponding PO index and each RACH occasion, or the RACH occasions has a corresponding RACH occasion index. The rule can indicate that each PO of the PF or the PFs maps to each RACH occasion or the RACH occasions in an ascending order of indexes. In some cases, one or more paging resources are mapped to one or more RACH occasions according to the ascending order of indexes, including a PO index of the PO of the received paging message and a RACH occasion index of the RACH occasion.

At 710, the UE 104 can select a RACH occasion for random access. For example, the UE 104 can select a RACH occasion to use for a RACH message of a random access procedure. The random access refers to a procedure used by the UE 104 to initiate communications with the NE 102, request resources, and establish initial connections. The RACH message can include a first message (e.g., msg1) of the random access procedure. The RACH occasion can be a physical RACH (PRACH) occasion. In some cases, the random access procedure can include two messages, where the second message is a response from the NE 102 that acknowledges the first message. In some other cases, the random access procedure can include four messages. In some examples, the UE 104 selects the RACH occasion with a quantity of resources of PO in a frequency domain that is equal to a quantity of resources of the RACH occasion in the frequency domain.

At 712, the UE 104 can transmit a RACH message to the NE 102. For example, the UE 104 can transmit the RACH message to the NE 102 in the selected RACH occasion.

In some cases, at 714, the NE 102 can transmit a downlink message to the UE 104. For example, the paging message can cause the UE 104 to enter an active mode to receive the downlink message. A UE 104 receiving the downlink message can be referred to as mobile terminated traffic. If the UE 104 were to transmit an uplink message to the NE 102, then the transmission would be referred to as mobile originated traffic. In some examples, the UE maps the paging resource to the RACH occasion according to the rule for mobile terminated traffic.

In some examples, the PF includes a set of resources, and the PO includes a subset of those resources. The paging resource can include one or more PFs and/or one or more POs. Thus, the set of resources and/or the subset of resources can include the paging resource.

FIG. 8 illustrates an example of a RACH configuration 800 in accordance with aspects of the present disclosure. In some examples, the RACH configuration 800 implements or is implemented by aspects of the wireless communications system 100, the transmission diagram 200, the transmission diagram 300, the transmission diagram 400, the resource mapping diagram 500, the resource mapping diagram 600, and the signaling diagram 700. For example, the RACH configuration 800 can be implemented by a UE and a NE, which may be examples of a UE 104 and a NE 102 as described with reference to FIG. 1. The NE and/or the UE can implement mapping between resources used for a paging message and resources used for a RACH message to reduce, or prevent, collisions between RACH messages. The RACH configuration 800 can include a portion of a configuration for mapping an SSB to one or more RACH occasions.

FIG. 9 illustrates an example of a RACH configuration 900 in accordance with aspects of the present disclosure. In some examples, the RACH configuration 900 implements or is implemented by aspects of the wireless communications system 100, the transmission diagram 200, the transmission diagram 300, the transmission diagram 400, the resource mapping diagram 500, the resource mapping diagram 600, the signaling diagram 700, and the RACH configuration 800. For example, the RACH configuration 900 can be implemented by a UE and a NE, which may be examples of a UE 104 and a NE 102 as described with reference to FIG. 1. The NE and/or the UE can implement mapping between resources used for a paging message and resources used for a RACH message to reduce, or prevent, collisions between RACH messages. The RACH configuration 900 can include a portion of a configuration for mapping an SSB to one or more RACH occasions.

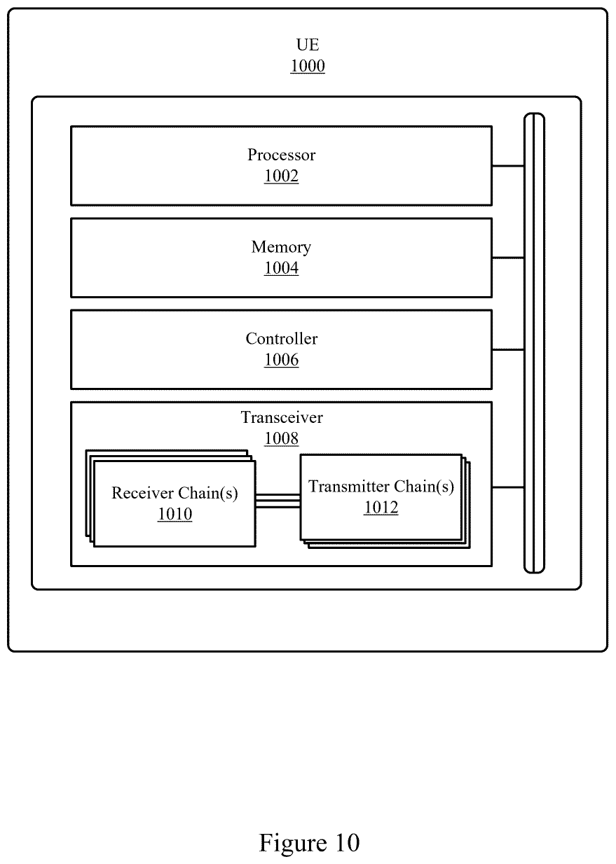

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving a paging message during a PO associated with a PF of a set of PFs that are consecutive in a time domain, mapping, according to a rule, at least one resource associated with the paging message to a RACH occasion of a set of RACH occasions, selecting the RACH occasion for random access, and transmitting a RACH message during the selected RACH occasion.

Additionally, the UE 1000 may be configured to support any one or combination of receiving control signaling including at least one parameter that indicates the rule, where the control signaling includes RRC signaling. Additionally, or alternatively, the at least one parameter indicates at least one of a subdivision value, subfactor value, or factor value deriving a resource associated with the PO and the RACH occasion based on a set of resources mapped between an SSB and one or more RACH occasions including the RACH occasion, and the at least one resource includes the resource. Additionally, or alternatively, the control signaling includes at least one additional parameter that indicates that an SSB corresponds to one or more RACH occasions including the RACH occasion, and the rule indicates that the one or more RACH occasions correspond to a set of POs within at least one PF of the set of PFs.

Additionally, or alternatively, the rule indicates a numerical quantity of messages within respective RACH occasions of the one or more RACH occasions that corresponds to the set of POs within the at least one PF of the set of PFs. Additionally, or alternatively, the rule indicates that a group of POs associated with the PF corresponds to at least one RACH occasion including the RACH occasion, and the group of POs includes the PO. Additionally, or alternatively, the rule indicates that at least one of a group of POs associated with the set of PFs or the set of PFs corresponds to one or more RACH occasions including the RACH occasion. Additionally, or alternatively, a quantity of resources associated with the PO in a frequency domain is equal to a quantity of resources associated with the RACH occasion in the frequency domain, and where to select the RACH occasion is based on the quantity of resources associated with the PO in the frequency domain being equal to the quantity of resources associated with the RACH occasion in the frequency domain.

Additionally, or alternatively, each PO associated with the PF or the set of PFs includes a corresponding PO index, each RACH occasion or the set of RACH occasions includes a corresponding RACH occasion index, the rule indicates that each PO associated with the PF or the set of PFs maps to each RACH occasion or the set of RACH occasions in an ascending order of indices, and the at least one resource associated with the paging message is mapped to the RACH occasion according to the ascending order of indices and based on a PO index of the PO associated with the received paging message and a RACH occasion index associated with the RACH occasion. Additionally, or alternatively, the PF includes a set of resources, the PO includes a subset of resources of the set of resources, and at least one of the set of resources or the subset of resources includes the at least one resource. Additionally, or alternatively, the UE 1000 may be configured to support receiving, from a base station and based on the paging message, a downlink message, where the at least one resource associated with the paging message is mapped to the RACH occasion based on the UE receiving the downlink message.

Additionally, or alternatively, the UE 1000 may support at least one memory (e.g., the memory 1004) and at least one processor (e.g., the processor 1002) coupled with the at least one memory and configured to cause the UE to receive a paging message during a PO associated with a PF of a set of paging frames that are consecutive in a time domain, map, according to a rule, at least one resource associated with the paging message to a RACH occasion of a set of RACH occasions, select the RACH occasion for random access, and transmit a RACH message during the selected RACH occasion

Additionally, the UE 1000 may be configured to support any one or combination of the at least one processor is configured to receive control signaling including at least one parameter that indicates the rule, where the control signaling includes RRC signaling. Additionally, or alternatively, the at least one parameter indicates at least one of a subdivision value, subfactor value, or factor value deriving a resource associated with the PO and the RACH occasion based on a set of resources mapped between an SSB and one or more RACH occasions including the RACH occasion, and the at least one resource includes the resource. Additionally, or alternatively, the control signaling includes at least one additional parameter that indicates that an SSB corresponds to one or more RACH occasions including the RACH occasion, and the rule indicates that the one or more RACH occasions correspond to a set of POs within at least one PF of the set of PFs.

Additionally, or alternatively, the rule indicates a numerical quantity of messages within respective RACH occasions of the one or more RACH occasions that corresponds to the set of POs within the at least one PF of the set of PFs. Additionally, or alternatively, the rule indicates that a group of POs associated with the PF corresponds to at least one RACH occasion including the RACH occasion, and the group of POs includes the PO. Additionally, or alternatively, the rule indicates that at least one of a group of POs associated with the set of PFs or the set of PFs corresponds to one or more RACH occasions including the RACH occasion. Additionally, or alternatively, a quantity of resources associated with the PO in a frequency domain is equal to a quantity of resources associated with the RACH occasion in the frequency domain, and where to select the RACH occasion is based on the quantity of resources associated with the PO in the frequency domain being equal to the quantity of resources associated with the RACH occasion in the frequency domain.

Additionally, or alternatively, each PO associated with the PF or the set of PFs includes a corresponding PO index, each RACH occasion or the set of RACH occasions includes a corresponding RACH occasion index, the rule indicates that each PO associated with the PF or the set of PFs maps to each RACH occasion or the set of RACH occasions in an ascending order of indices, and the at least one resource associated with the paging message is mapped to the RACH occasion according to the ascending order of indices and based on a PO index of the PO associated with the received paging message and a RACH occasion index associated with the RACH occasion. Additionally, or alternatively, the PF includes a set of resources, the PO includes a subset of resources of the set of resources, and at least one of the set of resources or the subset of resources includes the at least one resource. Additionally, or alternatively, the at least one processor is configured to receive, from a base station and based on the paging message, a downlink message, where the at least one resource associated with the paging message is mapped to the RACH occasion based on the UE receiving the downlink message.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

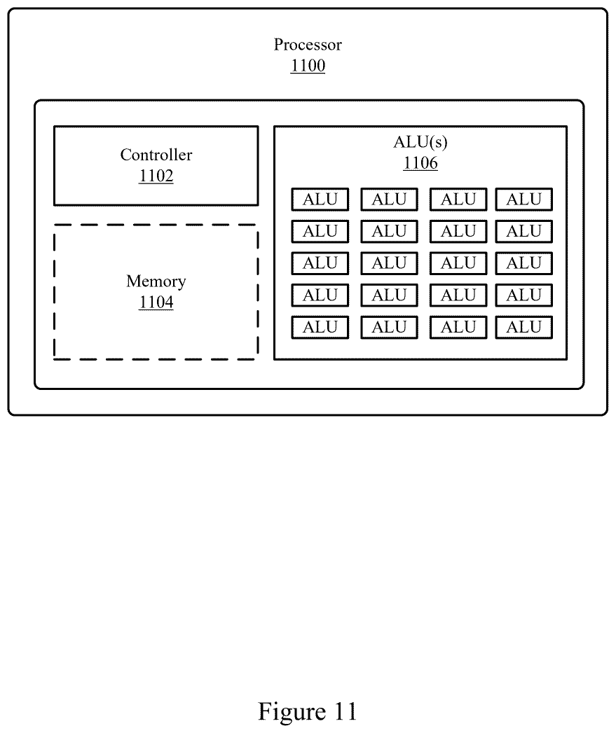

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a paging message during a PO associated with a PF of a set of PFs that are consecutive in a time domain, map, according to a rule, at least one resource associated with the paging message to a RACH occasion of a set of RACH occasions, select the RACH occasion for random access, and transmit a RACH message during the selected RACH occasion.

Additionally, the processor 1100 may be configured to or operable to support any one or combination of the at least one controller is configured to cause the processor to receive control signaling including at least one parameter that indicates the rule, where the control signaling includes RRC signaling. Additionally, or alternatively, the at least one parameter indicates at least one of a subdivision value, subfactor value, or factor value deriving a resource associated with the PO and the RACH occasion based on a set of resources mapped between an SSB and one or more RACH occasions including the RACH occasion, and the at least one resource includes the resource. Additionally, or alternatively, the control signaling includes at least one additional parameter that indicates that an SSB corresponds to one or more RACH occasions including the RACH occasion, and the rule indicates that the one or more RACH occasions correspond to a set of POs within at least one PF of the set of PFs.

Additionally, or alternatively, the rule indicates a numerical quantity of messages within respective RACH occasions of the one or more RACH occasions that corresponds to the set of POs within the at least one PF of the set of PFs. Additionally, or alternatively, the rule indicates that a group of POs associated with the PF corresponds to at least one RACH occasion including the RACH occasion, and the group of POs includes the PO. Additionally, or alternatively, the rule indicates that at least one of a group of POs associated with the set of PFs or the set of PFs corresponds to one or more RACH occasions including the RACH occasion. Additionally, or alternatively, a quantity of resources associated with the PO in a frequency domain is equal to a quantity of resources associated with the RACH occasion in the frequency domain, and where to select the RACH occasion is based on the quantity of resources associated with the PO in the frequency domain being equal to the quantity of resources associated with the RACH occasion in the frequency domain.

Additionally, or alternatively, each PO associated with the PF or the set of PFs includes a corresponding PO index, each RACH occasion or the set of RACH occasions includes a corresponding RACH occasion index, the rule indicates that each PO associated with the PF or the set of PFs maps to each RACH occasion or the set of RACH occasions in an ascending order of indices, and the at least one resource associated with the paging message is mapped to the RACH occasion according to the ascending order of indices and based on a PO index of the PO associated with the received paging message and a RACH occasion index associated with the RACH occasion. Additionally, or alternatively, the PF includes a set of resources, the PO includes a subset of resources of the set of resources, and at least one of the set of resources or the subset of resources includes the at least one resource. Additionally, or alternatively, the at least one controller is configured to cause the processor to receive, from a base station and based on the paging message, a downlink message, where the at least one resource associated with the paging message is mapped to the RACH occasion based on the processor receiving the downlink message.

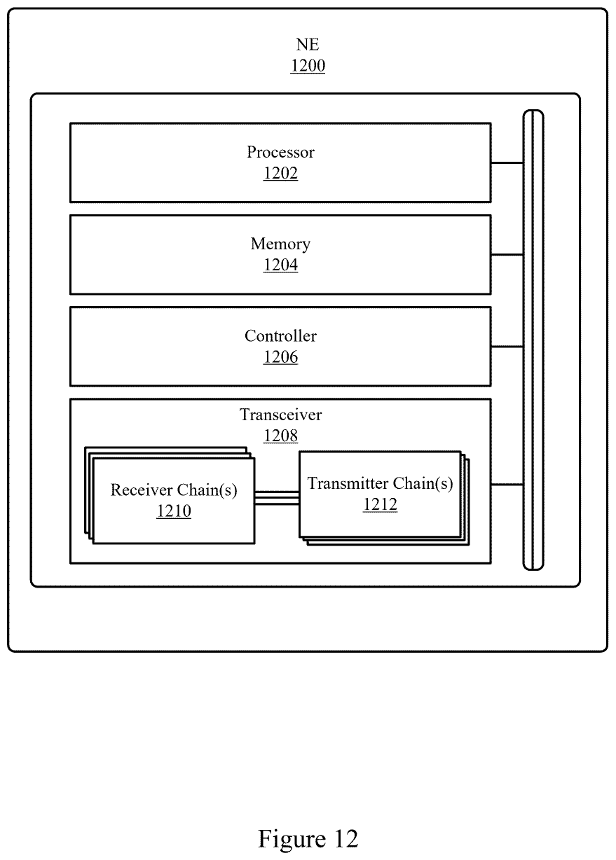

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting a paging message during a PO associated with a PF of a set of PFs that are consecutive in a time domain, and receiving, during a RACH occasion of a set of RACH occasions, a RACH message based on a mapping, according to a rule, between the RACH occasion and at least one resource associated with the paging message.

Additionally, the NE 1200 may be configured to or operable to support any one or combination of the method further comprising transmitting control signaling including at least one parameter that indicates the rule, where the control signaling includes RRC signaling. Additionally, or alternatively, the at least one parameter indicates at least one of a subdivision value, subfactor value, or factor value deriving a resource associated with the PO and the RACH occasion based on a set of resources mapped between an SSB and one or more RACH occasions including the RACH occasion, and the at least one resource includes the resource.

Additionally, or alternatively, the control signaling includes at least one additional parameter that indicates that an SSB corresponds to one or more RACH occasions including the RACH occasion, and the rule indicates that the one or more RACH occasions correspond to a set of POs within at least one PF of the set of PFs. Additionally, or alternatively, the rule indicates that a group of POs associated with the PF corresponds to at least one RACH occasion including the RACH occasion, and the group of POs includes the PO. Additionally, or alternatively, the rule indicates that at least one of a group of POs associated with the set of PFs or the set of PFs corresponds to one or more RACH occasions including the RACH occasion. Additionally, or alternatively, a quantity of resources associated with the PO in a frequency domain is equal to a quantity of resources associated with the RACH occasion in the frequency domain.

Additionally, or alternatively, each PO associated with the PF or the set of PFs includes a corresponding PO index, each RACH occasion or the set of RACH occasions includes a corresponding RACH occasion index, the rule indicates that each PO associated with the PF or the set of PFs maps to each RACH occasion or the set of RACH occasions in an ascending order of indices, and the at least one resource associated with the paging message is mapped to the RACH occasion according to the ascending order of indices and based on a PO index of the PO associated with the received paging message and a RACH occasion index associated with the RACH occasion. Additionally, or alternatively, the PF includes a set of resources, the PO includes a subset of resources of the set of resources, and at least one of the set of resources or the subset of resources includes the at least one resource. Additionally, or alternatively, the NE 1200 may be configured to or operable to support the method further comprising transmitting, to a UE and based on the paging message, a downlink message, and where the at least one resource associated with the paging message is mapped to the RACH occasion based on the downlink message.

Additionally, or alternatively, the NE 1200 may support at least one memory (e.g., the memory 1204) and at least one processor (e.g., the processor 1202) coupled with the at least one memory and configured to cause the NE to transmit a paging message during a PO associated with a PF of a set of PFs that are consecutive in a time domain, and receive, during a RACH occasion of a set of RACH occasions, a RACH message based on a mapping, according to a rule, between the RACH occasion and at least one resource associated with the paging message.

Additionally, the NE 1200 may be configured to support any one or combination of the at least one processor is configured to cause the NE to transmit control signaling including at least one parameter that indicates the rule, where the control signaling includes RRC signaling. Additionally, or alternatively, the at least one parameter indicates at least one of a subdivision value, subfactor value, or factor value deriving a resource associated with the PO and the RACH occasion based on a set of resources mapped between an SSB and one or more RACH occasions including the RACH occasion, and the at least one resource includes the resource.

Additionally, or alternatively, the control signaling includes at least one additional parameter that indicates that an SSB corresponds to one or more RACH occasions including the RACH occasion, and the rule indicates that the one or more RACH occasions correspond to a set of POs within at least one PF of the set of PFs. Additionally, or alternatively, the rule indicates that a group of POs associated with the PF corresponds to at least one RACH occasion including the RACH occasion, and the group of POs includes the PO. Additionally, or alternatively, the rule indicates that at least one of a group of POs associated with the set of PFs or the set of PFs corresponds to one or more RACH occasions including the RACH occasion. Additionally, or alternatively, a quantity of resources associated with the PO in a frequency domain is equal to a quantity of resources associated with the RACH occasion in the frequency domain.

Additionally, or alternatively, each PO associated with the PF or the set of PFs includes a corresponding PO index, each RACH occasion or the set of RACH occasions includes a corresponding RACH occasion index, the rule indicates that each PO associated with the PF or the set of PFs maps to each RACH occasion or the set of RACH occasions in an ascending order of indices, and the at least one resource associated with the paging message is mapped to the RACH occasion according to the ascending order of indices and based on a PO index of the PO associated with the received paging message and a RACH occasion index associated with the RACH occasion. Additionally, or alternatively, the PF includes a set of resources, the PO includes a subset of resources of the set of resources, and at least one of the set of resources or the subset of resources includes the at least one resource. Additionally, or alternatively, the at least one processor is configured to cause the NE to transmit, to a UE and based on the paging message, a downlink message, and where the at least one resource associated with the paging message is mapped to the RACH occasion based on the downlink message.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

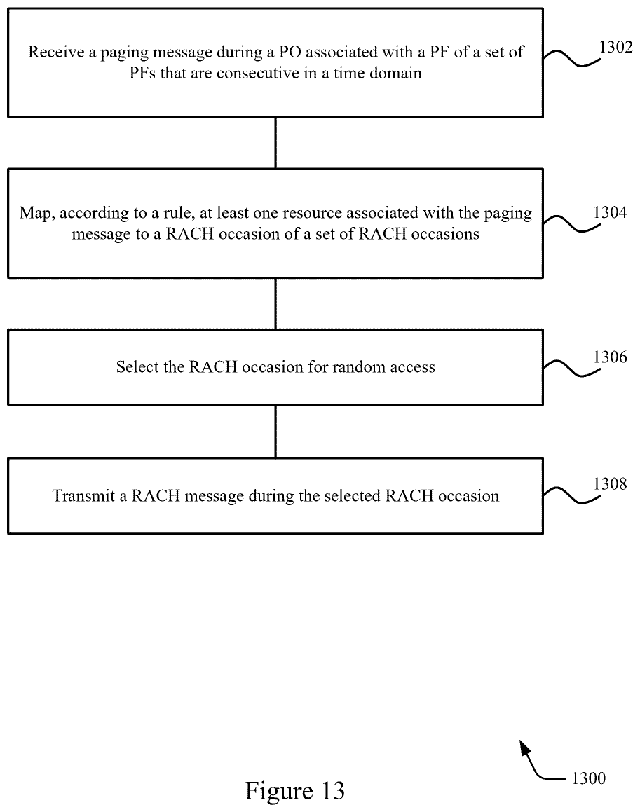

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving a paging message during a PO associated with a PF of a set of PFs that are consecutive in a time domain. The operations of 1302 may be performed in accordance with examples as described herein. In some implementations, aspects of the operations of 1302 may be performed by a UE as described with reference to FIG. 10.

At 1304, the method may include mapping, according to a rule, at least one resource associated with the paging message to a RACH occasion of a set of RACH occasions. The operations of 1304 may be performed in accordance with examples as described herein. In some implementations, aspects of the operations of 1304 may be performed by a UE as described with reference to FIG. 10.

At 1306, the method may include selecting the RACH occasion for random access. The operations of 1306 may be performed in accordance with examples as described herein. In some implementations, aspects of the operations of 1306 may be performed a UE as described with reference to FIG. 10.

At 1308, the method may include transmitting a RACH message during the selected RACH occasion. The operations of 1308 may be performed in accordance with examples as described herein. In some implementations, aspects of the operations of 1308 may be performed a UE as described with reference to FIG. 10.

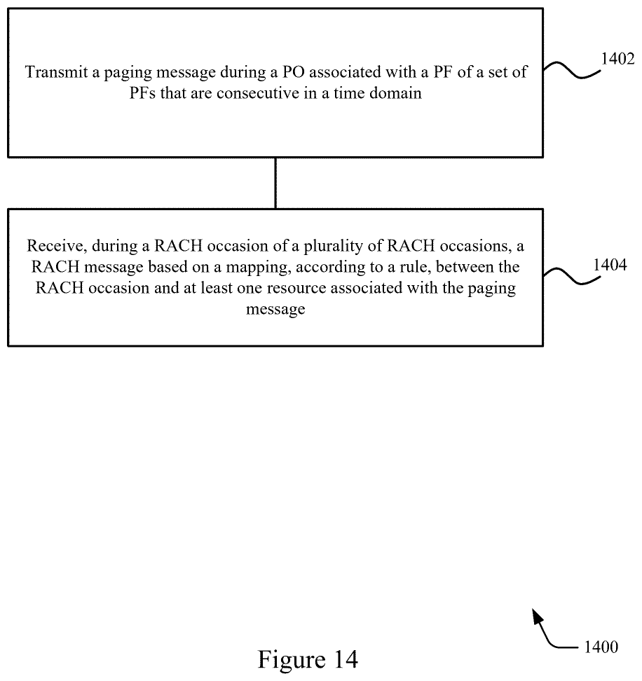

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting a paging message during a PO associated with a PF of a set of PFs that are consecutive in a time domain. The operations of 1402 may be performed in accordance with examples as described herein. In some implementations, aspects of the operations of 1402 may be performed by a NE as described with reference to FIG. 12.

At 1404, the method may include receiving, during a RACH occasion of a plurality of RACH occasions, a RACH message based on a mapping, according to a rule, between the RACH occasion and at least one resource associated with the paging message The operations of 1404 may be performed in accordance with examples as described herein. In some implementations, aspects of the operations of 1404 may be performed by a NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a paging message during a paging occasion associated with a paging frame of a plurality of paging frames that are consecutive in a time domain;
map, according to a rule, at least one resource associated with the paging message to a random access channel occasion of a plurality of random access channel occasions;
select the random access channel occasion for random access; and
transmit a random access channel message during the selected random access channel occasion.

2. The UE of claim 1, wherein the at least one processor is configured to cause the UE to receive control signaling comprising at least one parameter that indicates the rule, wherein the control signaling comprises radio resource control (RRC) signaling.

3. The UE of claim 2, wherein:
the at least one parameter indicates at least one of a subdivision value, subfactor value, or factor value deriving a resource associated with the paging occasion and the random access channel occasion based at least in part on a plurality of resources mapped between a synchronization signal block (SSB) and one or more random access channel occasions comprising the random access channel occasion; and
the at least one resource comprises the resource.

4. The UE of claim 2, wherein:
the control signaling comprises at least one additional parameter that indicates that a synchronization signal block (SSB) corresponds to one or more random access channel occasions comprising the random access channel occasion; and
the rule indicates that the one or more random access channel occasions correspond to a plurality of paging occasions within at least one paging frame of the plurality of paging frames.

5. The UE of claim 4, wherein the rule indicates a numerical quantity of messages within respective random access channel occasions of the one or more random access channel occasions that corresponds to the plurality of paging occasions within the at least one paging frame of the plurality of paging frames.

6. The UE of claim 1, wherein:
the rule indicates that a group of paging occasions associated with the paging frame corresponds to at least one random access channel occasion comprising the random access channel occasion; and
the group of paging occasions comprises the paging occasion.

7. The UE of claim 1, wherein the rule indicates that at least one of a group of paging occasions associated with the plurality of paging frames or the plurality of paging frames corresponds to one or more random access channel occasions comprising the random access channel occasion.

8. The UE of claim 1, wherein a quantity of resources associated with the paging occasion in a frequency domain is equal to a quantity of resources associated with the random access channel occasion in the frequency domain, and wherein to select the random access channel occasion is based at least in part on the quantity of resources associated with the paging occasion in the frequency domain being equal to the quantity of resources associated with the random access channel occasion in the frequency domain.

9. The UE of claim 1, wherein:
each paging occasion associated with the paging frame or the plurality of paging frames comprises a corresponding paging occasion index;
each random access channel occasion or the plurality of random access channel occasions comprises a corresponding random access channel occasion index;
the rule indicates that each paging occasion associated with the paging frame or the plurality of paging frames maps to each random access channel occasion or the plurality of random access channel occasions in an ascending order of indices; and
the at least one resource associated with the paging message is mapped to the random access channel occasion according to the ascending order of indices and based at least in part on a paging occasion index of the paging occasion associated with the received paging message and a random access channel occasion index associated with the random access channel occasion.

10. The UE of claim 1, wherein:
the paging frame comprises a set of resources;
the paging occasion comprises a subset of resources of the set of resources; and
at least one of the set of resources or the subset of resources comprises the at least one resource.

11. The UE of claim 1, wherein the at least one processor is configured to cause the UE to receive, from a base station and based at least in part on the paging message, a downlink message, and wherein the at least one resource associated with the paging message is mapped to the random access channel occasion based at least in part on the UE receiving the downlink message.

12. A processor for wireless communication, comprising:
at least one controller coupled with at least one memory and configured to cause the processor to:
receive a paging message during a paging occasion associated with a paging frame of a plurality of paging frames that are consecutive in a time domain;
map, according to a rule, at least one resource associated with the paging message to a random access channel occasion of a plurality of random access channel occasions;
select the random access channel occasion for random access; and
transmit a random access channel message during the selected random access channel occasion.

13. A method performed by a user equipment (UE), the method comprising:
receiving a paging message during a paging occasion associated with a paging frame of a plurality of paging frames that are consecutive in a time domain;
mapping, according to a rule, at least one resource associated with the paging message to a random access channel occasion of a plurality of random access channel occasions;
selecting the random access channel occasion for random access; and
transmitting a random access channel message during the selected random access channel occasion.

14. A base station for wireless communication, comprising:
at least one memory; and
at least one processor coupled with the at least one memory and configured to cause the base station to:
transmit a paging message during a paging occasion associated with a paging frame of a plurality of paging frames that are consecutive in a time domain; and
receive, during a random access channel occasion of a plurality of random access channel occasions, a random access channel message based at least in part on a mapping, according to a rule, between the random access channel occasion and at least one resource associated with the paging message.

15. The base station of claim 14, wherein the at least one processor is configured to cause the base station to transmit control signaling comprising at least one parameter that indicates the rule, wherein the control signaling comprises radio resource control (RRC) signaling.

16. The base station of claim 15, wherein:
the at least one parameter indicates at least one of a subdivision value, subfactor value, or factor value deriving a resource associated with the paging occasion and the random access channel occasion based at least in part on a plurality of resources mapped between a synchronization signal block (SSB) and one or more random access channel occasions comprising the random access channel occasion; and
the at least one resource comprises the resource.

17. The base station of claim 15, wherein:
the control signaling comprises at least one additional parameter that indicates that a synchronization signal block (SSB) corresponds to one or more random access channel occasions comprising the random access channel occasion; and
the rule indicates that the one or more random access channel occasions correspond to a plurality of paging occasions within at least one paging frame of the plurality of paging frames.

18. The base station of claim 14, wherein:
the rule indicates that a group of paging occasions associated with the paging frame corresponds to at least one random access channel occasion comprising the random access channel occasion; and
the group of paging occasions comprises the paging occasion.

19. The base station of claim 14, wherein the rule indicates that at least one of a group of paging occasions associated with the plurality of paging frames or the plurality of paging frames corresponds to one or more random access channel occasions comprising the random access channel occasion.

20. The base station of claim 14, wherein a quantity of resources associated with the paging occasion in a frequency domain is equal to a quantity of resources associated with the random access channel occasion in the frequency domain.
